(19) United States
(12) Patent Application Publication
(10) Pub. No.: US 2020/0249199 A1
(43) Pub. Date: Aug. 6, 2020

(54) Capillary Electrophoresis Apparatus

(71) Applicant: Hitachi High-Tech Corporation, Minato-ku, Tokyo (JP)

(72) Inventors: Asami TERAKADO, Tokyo (JP); Michiru FUJIOKA, Tokyo (JP)

(21) Appl. No.: 16/650,648

(22) PCT Filed: Sep. 25, 2018
(86) PCT No.: PCT/JP2018/035271

§ 371 Date: Mar. 25, 2020

(30) Foreign Application Priority Data
Sep. 26, 2017 (JP) 2017-184309

(51) Int. Cl. G01N 27/447

(52) U.S. Cl. CPC G01N 27/44743; G01N 27/44782

(57) ABSTRACT

In an electrophoresis apparatus using a capillary, electrophoresis using a single capillary sometimes requires replacement of a sieving matrix. Replacement with a different sieving matrix has conventionally required cleaning with sieving matrix cleaning liquid, which has increased costs and time required. An electrophoresis apparatus according to the present invention comprises an anodic capillary head provided at a distal end of the capillary, a sieving matrix container filled with a sieving matrix used for electrophoresis, and a filling mechanism for filling the capillary with the sieving matrix via the sieving matrix container. The filling mechanism fills the capillary, which is already filled with the sieving matrix, with a sieving matrix different from the already-filled sieving matrix without using sieving matrix cleaning liquid.

### TECHNICAL FIELD

The present invention relates to a capillary electrophoresis apparatus for separating and analyzing nucleic acids, proteins, and the like.

### BACKGROUND ART

In recent years, an electrophoresis apparatus using a capillary is used for various separation and analysis measurements including nucleic acid and protein analysis. As compared to a gel electrophoresis apparatus, the electrophoresis apparatus using the capillary can perform electrophoresis using a capillary for each sample, and therefore, a higher voltage can be applied to the sample without contamination between the samples, and the electrophoresis can be performed at a high speed.

Further, continuous use such as automatic filling and exchanging of a sieving matrix and automatic injection of a sample has been possible, so that wide utilization and a short-time separation and analysis measurement by one apparatus are required.

In PTL 1, filling of the sieving matrix is performed by a syringe pump. There is a relay flow path block provided with a syringe pump function. The relay flow path block is connected to the capillary, and the sieving matrix is sucked with the syringe pump, and is discharged to the capillary so as to perform the filling of the sieving matrix. A buffer for performing the electrophoresis is also connected to the relay flow path block, and the flow path is switched by opening and closing a valve in the relay flow path block.

In PTL 2, the sieving matrix is injected from a sieving matrix filling cartridge filled with the sieving matrix into a capillary head provided at a tip end of the capillary without using the syringe pump. As compared to the case where the syringe pump is used, a running cost can be reduced and user workability can be improved.

Generally, the sieving matrix is selected and used for the separation and analysis measurement according to a purpose and an application. Therefore, in the electrophoresis apparatus using the capillary, when different separation and analysis measurements are performed using the same capillary, it may be necessary to exchange the sieving matrix. In this case, before the capillary is filled with a different sieving matrix, an inside of the capillary is cleaned with a sieving matrix cleaning liquid. Then, after the inside of the capillary is cleaned, a replacement of the sieving matrix is required, and generally the sieving matrix several times a capacity of the capillary is required. This is because when the sieving matrix cleaning liquid remains in the capillary and electrophoresis is performed in a state where the sieving matrix cleaning liquid and the sieving matrix are mixed, a separation and analysis performance is reduced.

### CITATION LIST

### Patent Literature

PTL 1: JP-A-2008-8621

PTL 2: WO 2016/157272

### SUMMARY OF INVENTION

### Technical Problem

In the electrophoresis apparatus using the capillary, when the electrophoresis is performed using the same capillary, the sieving matrix may be changed. As described above, in the related art, in order to perform the cleaning with the sieving matrix cleaning liquid before a different sieving matrix is fed to the capillary, a sieving matrix cleaning liquid, and a replacement between the sieving matrix cleaning liquid and the sieving matrix such as a cleaning step, and a sieving matrix exchange are required.

An object of the invention is to provide a capillary electrophoresis apparatus that reduces labor, cost, time, and the like of the above-described work due to the exchange of the sieving matrix.

### Solution to Problem

To achieve the above purpose, the invention provides a capillary electrophoresis apparatus configured to feed a sample into a capillary with electrophoresis and optically detect the sample. The capillary electrophoresis apparatus includes a capillary head provided at a tip end of the capillary; a sieving matrix cartridge filled with a sieving matrix for the electrophoresis; and a mechanism configured to fill the capillary with the sieving matrix from the sieving matrix cartridge, and the capillary filled with the sieving matrix is filled with a different sieving matrix without using a sieving matrix cleaning liquid.

### Advantageous Effect

According to the invention, the sieving matrix cleaning liquid is reduced, the replacement step between the sieving matrix cleaning liquid and the sieving matrix such as the cleaning step, and the sieving matrix exchange is eliminated, and it is possible to improve the efficiency such as cost reduction and work time reduction.

### BRIEF DESCRIPTION OF DRAWINGS

FIG. 1 is a schematic diagram showing a configuration of a capillary electrophoresis apparatus.

FIG. 2 is a top view of the capillary electrophoresis apparatus.

FIG. 3 is a cross-sectional view taken along A-A of the capillary electrophoresis apparatus.

FIG. 4 is an analysis workflow.

FIG. 5 is a sieving matrix exchange workflow.

FIG. 6 is a sieving matrix exchange GUI (information of a sieving matrix before exchange).

FIG. 7 is a sieving matrix exchange GUI (reading the sieving matrix to be exchanged).

FIG. 8 is a sieving matrix exchange GUI (information of the sieving matrix to be exchanged).

FIG. 9 is a sieving matrix exchange GUI (attaching the sieving matrix cartridge to be exchanged).

FIG. 10 is a sieving matrix exchange GUI (filling of the sieving matrix to be exchanged).

### DESCRIPTION OF EMBODIMENTS

Hereinafter, various embodiments of the invention will be described with reference to the drawings. In all the drawings for describing the various embodiments, components having the same function are denoted by the same reference numerals.

### First Embodiment

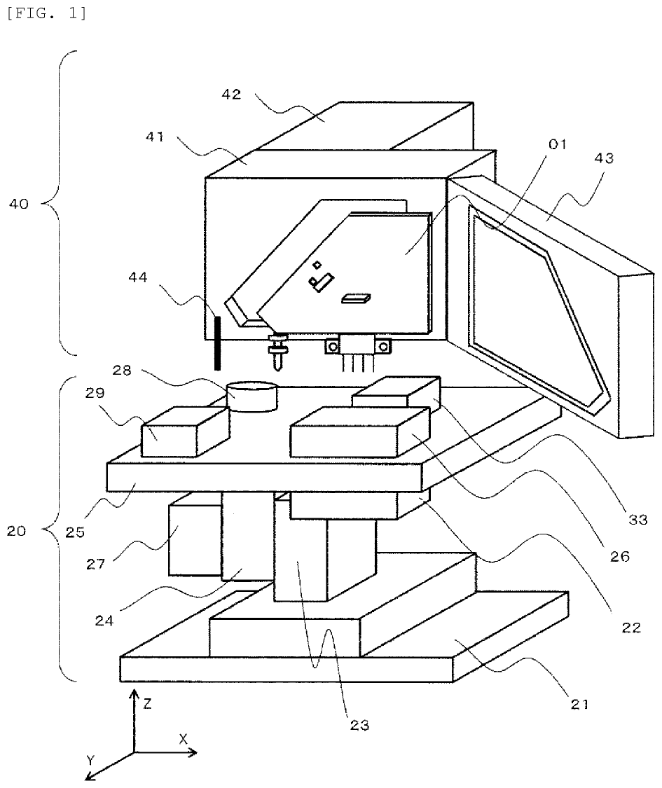

Hereinafter, a capillary cartridge of a first embodiment and a configuration and an arrangement of an electrophoresis apparatus using the capillary cartridge will be described with reference to FIGS. 1 to 3. FIG. 1 is a diagram showing a device configuration of the capillary electrophoresis apparatus of the first embodiment. The present apparatus can be broadly divided into two units, an optics and oven unit 40 at an upper portion of the apparatus and an autosampler unit 20 at a lower portion of the apparatus.

In the autosampler unit 20, which is an injection mechanism, a Y-axis driver 23 is mounted on a sampler base 21 and can drive a movement in a Y axis. A Z-axis driver 24 is mounted on the Y-axis driver 23 and can drive a movement in a Z axis. A sample tray 25 is mounted on the Z-axis driver 24, and a user sets a sieving matrix cartridge 28, an anode buffer cartridge 29, a cathode buffer cartridge 33, and a sample cartridge 26 on the sample tray 25. The sample cartridge 26 is set above an X-axis driver 22 mounted on the sample tray 25, and only the sample cartridge 26 can be driven to move in the X axis on the sample tray 25. A liquid feeding mechanism 27 is also mounted on the Z-axis driver 24. The liquid feeding mechanism 27 is provided below the sieving matrix cartridge 28.

The optics and oven unit 40 includes an oven unit 41 and an oven door 43 which are the above-described oven, and an inside thereof can be maintained at a constant temperature. An optics unit 42 which is the above-described irradiation and detection unit, is mounted behind the oven unit 41, and can perform detection during the electrophoresis. The user sets a capillary cartridge 01 which will be described in detail later in the oven unit 41, the electrophoresis is performed while keeping the capillary at a constant temperature in the oven unit 41, and detection is performed by the optics unit 42. Further, the oven unit 41 is also provided with an electrode (anode) 44 for dropping a voltage to GND when a high voltage for the electrophoresis is applied.

The capillary cartridge 01 is fixed in the oven unit 41. The sieving matrix cartridge 28, the anode buffer cartridge 29, the cathode buffer cartridge 33, and the sample cartridge 26 can be driven to move in the Y and Z axes in the autosampler unit 20, and only the sample cartridge 26 can be further driven to move in the X axis. The sieving matrix cartridge 28, the anode buffer cartridge 29, the cathode buffer cartridge 33, and the sample cartridge 26 can be automatically connected to any position of the capillary in the fixed capillary cartridge 01 by a movement of the autosampler unit 20.

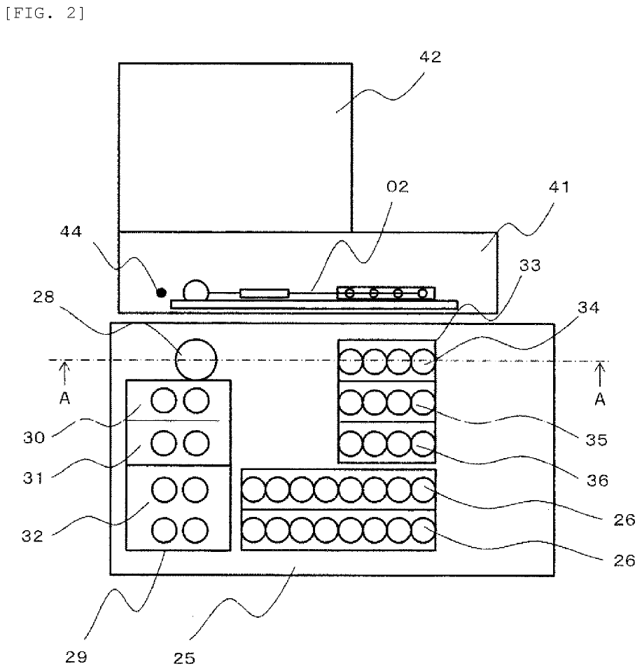

FIG. 2 shows a diagram of the capillary electrophoresis apparatus shown in FIG. 1 as viewed from above. The anode buffer cartridge 29 set on the sample tray 25 includes an anode electrophoresis buffer tank 30, an anode cleaning tank 31, and an anode sample injection buffer tank 32. Further, the cathode buffer cartridge 33 includes a waste liquid tank 34, a cathode electrophoresis buffer tank 35, and a cathode cleaning tank 36.

The sieving matrix cartridge 28, the anode buffer cartridge 29, the cathode buffer cartridge 33, and the sample cartridge 26 are arranged in a positional relationship as shown in the figure. Accordingly, the positional relationship between the anode side and the cathode side at the time of connection with a capillary 02 of the capillary cartridge in the oven unit 41 is “sieving matrix cartridge 28-waste liquid tank 34”, “anode electrophoresis buffer tank 30-cathode electrophoresis buffer tank 35”, “anode cleaning tank 31-cathode cleaning tank 36”, and “anode sample injection buffer tank 32-sample cartridge 26”.

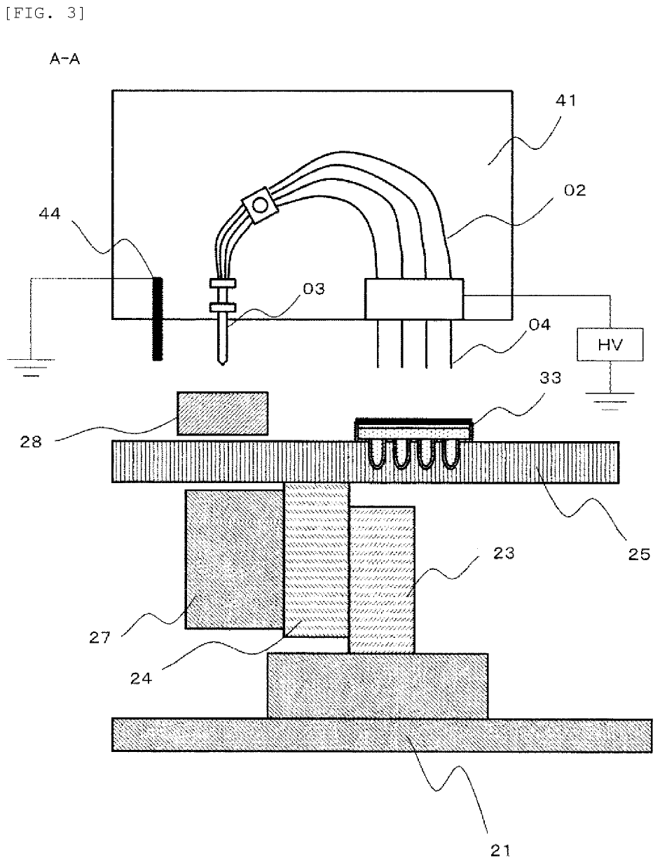

FIG. 3 shows a cross-sectional view taken along A-A in FIG. 2. The sieving matrix cartridge 28 is set on the sample tray 25. Further, the liquid feeding mechanism 27 is arranged such that a plunger built in the liquid feeding mechanism 27 is below the sieving matrix cartridge 28.

During the electrophoresis, a right side in FIG. 3 of the capillary 02 is the cathode side, and a left side is the anode side. The autosampler unit 20 moves a position of the “anode electrophoresis buffer tank 30-cathode electrophoresis buffer tank 35”, applies a high voltage to the capillary 02 on the cathode side, and causes a current to flow through the cathode buffer cartridge 33 and the anode buffer cartridge 29 to the GND through the electrode (anode) 44 so as to perform the electrophoresis. A device structure in which a position of the sample tray 25 is fixed and the optics and oven unit 40 is movable may be used.

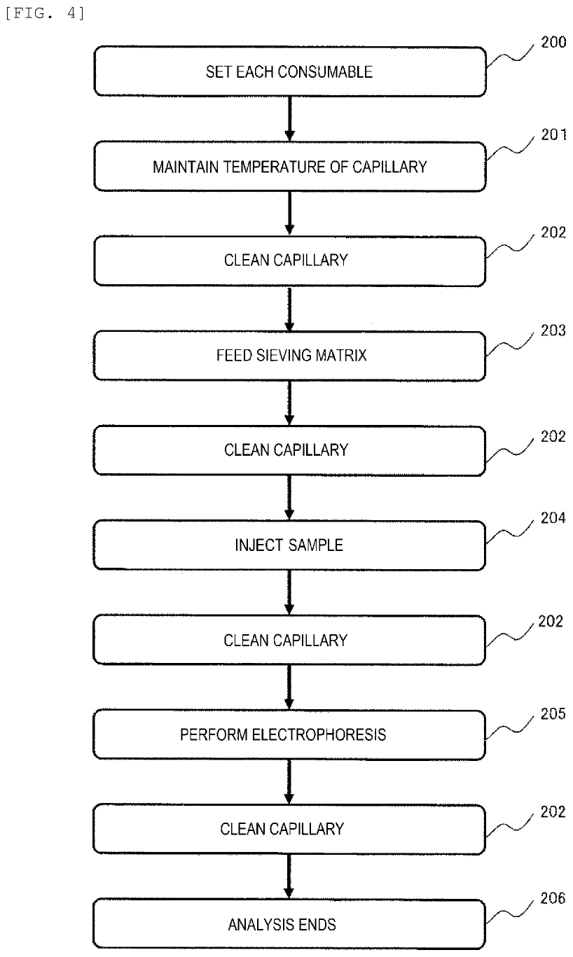

Next, an analysis workflow in the present embodiment will be described with reference to FIG. 4.

In step 200, the user sets the capillary cartridge 01 in the oven unit 41. Further, the user sets the sieving matrix cartridge 28, the anode buffer cartridge 29, the cathode buffer cartridge 33, and the sample cartridge 26 on the sample tray 25. Although not shown in the figure, a bar code is attached to each of the capillary cartridge 01, the sieving matrix cartridge 28, the anode buffer cartridge 29, and the cathode buffer cartridge 33 which are consumables. When setting each consumable in the apparatus, the user reads bar code information of each consumable using a bar code reader mounted on the apparatus. Accordingly, a production number, an expiration date, a use frequency, and the like of each consumable can be managed.

In step 201, the set capillary 02 is maintained at a constant temperature by the oven unit 41.

In step 202, a capillary head 03 of the capillary 02 and an electrode (cathode) 04 are inserted into the anode cleaning tank 31 and the cathode cleaning tank 36 by the movements of the Y-axis drive and the Z-axis drive of the autosampler unit 20, respectively. Accordingly, the capillary head 03 and the electrode (cathode) 04 are cleaned.

In step 203, the capillary head 03 of the capillary 02 and the electrode (cathode) 04 are inserted into the sieving matrix cartridge 28 and the waste liquid tank 34 by the movements of the Y-axis drive and the Z-axis drive of the autosampler unit 20, respectively. In this state, the liquid feeding mechanism 27 is driven to feed the sieving matrix sealed in the sieving matrix cartridge 28 to the capillary 02.

In step 202, the capillary head 03 of the capillary 02 and the electrode (cathode) 04 are inserted into the anode cleaning tank 31 and the cathode cleaning tank 36 again by the movements of the Y-axis drive and the Z-axis drive of the autosampler unit 20, respectively. Accordingly, the capillary head 03 and the electrode (cathode) 04 are cleaned.

In step 204, the capillary head 03 of the capillary 02 and the electrode (cathode) 04 are inserted into the anode sample injection buffer tank 32 and the sample cartridge 26 by the movements of the Y-axis drive and the Z-axis drive of the autosampler unit 20, respectively. At this time, the electrode 44 is also inserted into the anode sample injection buffer tank 32. Accordingly, both ends of the capillary 02 are electrically connected. In this state, the high voltage is applied, and a sample in the sample cartridge 26 is injected into the capillary 02.

In step 202, the capillary head 03 of the capillary 02 and the electrode (cathode) 04 are inserted into the anode cleaning tank 31 and the cathode cleaning tank 36 again by the movements of the Y-axis drive and the Z-axis drive of the autosampler unit 20, respectively. Accordingly, the capillary head 03 and the electrode (cathode) 04 are cleaned.

In step 205, the capillary head 03 of the capillary 02 and the electrode (cathode) 04 are inserted into the anode electrophoresis buffer tank 30 and the cathode electrophoresis buffer tank 35 again by the movements of the Y-axis drive and the Z-axis drive of the autosampler unit 20, respectively. At this time, the electrode 44 is also inserted into the anode electrophoresis buffer tank 30. Accordingly, both ends of the capillary 02 are electrically connected. In this state, the high voltage is applied, and the electrophoresis is performed. The electrophoresed sample is detected by the optics unit 42.

In step 202, the capillary head 03 of the capillary 02 and the electrode (cathode) 04 are inserted into the anode cleaning tank 31 and the cathode cleaning tank 36 again by the movements of the Y-axis drive and the Z-axis drive of the autosampler unit 20, respectively. Accordingly, the capillary head 03 and the electrode (cathode) 04 are cleaned.

One analysis is completed by analyzing the data detected by the series of movements. When the analysis is continuously performed using the same type of the sieving matrix, the X driver 22 on the sample tray 25 is driven to switch a position of the sample cartridge 26, and the above-described operation is repeated.

Next, a method of exchanging the sieving matrix established in the present embodiment will be described. As described in the problem to be solved by the invention, when a different sieving matrix is to be set, the cleaning using the sieving matrix cleaning liquid is generally performed. Then, after the inside of the capillary is cleaned with the sieving matrix cleaning liquid, a replacement with a sieving matrix is required, and generally the sieving matrix several times a capacity of the capillary is required. One of the reasons is that there is a difference in viscosity between the sieving matrix and the sieving matrix cleaning liquid. The sieving matrix used for the capillary electrophoresis has a high viscosity, for example, a viscosity of 100 cP or more, and may also be a sieving matrix having a viscosity of 300 cP or more. On the other hand, although depending on a type, a liquid having a viscosity of about 1 cP is used as the sieving matrix cleaning liquid. For example, when water is used as the sieving matrix cleaning liquid, a viscosity of water is about 0.89 cP, and the sieving matrix and the sieving matrix cleaning liquid have a viscosity difference of 100 times or more. Then, when the liquid is passed through the capillary, a difference in a flow velocity of the liquid occurs in a center portion in the capillary and a vicinity of an inner wall in the capillary, and the flow velocity in the central portion is higher than in the vicinity of the inner wall. When there is a large difference in the viscosity, the difference in the flow velocity of the liquid tends to occur between the center portion in the capillary and the vicinity of the inner wall in the capillary. Therefore, it is suggested that a region where liquids in the center portion and the vicinity of the inner wall in the capillary are different tends to increase, and a capacity of the liquid to be exchanged increases. Therefore, a liquid exchange in the capillary is verified using a liquid having a higher viscosity than the sieving matrix cleaning liquid, which is considered to tend to cause the difference in the flow velocity of the liquid between the center portion and the vicinity of the inner wall in the capillary. As a result, it is suggested that in the liquid replacement between the liquids having a high viscosity, the difference due to an effect of the viscosity in the center portion and the vicinity of the inner wall in the capillary is less likely to occur, and the liquid exchange may be achieved more easily than using the sieving matrix cleaning liquid. In a case of two types of liquid having a high viscosity, for example, in a case of two different sieving matrices, for example, in an exchange from a sieving matrix having a viscosity of about 100 cp to a sieving matrix having a viscosity of about 350 cp, the exchange is possible with a sieving matrix capacity required for the exchange being equal to or larger than a capacity of the capillary. The exchange is possible with the equal capacity in a flow velocity within an apparatus settable range. The exchange with equal capacity is similarly possible for an exchange from the sieving matrix having the viscosity of about 350 cp to the sieving matrix having the viscosity of about 100 cp.

Further, when comparing a separation performance obtained by exchanging the sieving matrix using the sieving matrix cleaning liquid with a separation performance obtained by exchanging the sieving matrix with the sieving matrix to be exchanged without using the sieving matrix cleaning liquid, it is obvious that an equivalent separation performance is obtained.

According to the above results, it is obvious that when the capillary filled with the sieving matrix is filled with a different sieving matrix without being subjected to a cleaning step using the sieving matrix cleaning liquid, it is possible to exchange the sieving matrix in a shorter time than using the sieving matrix cleaning liquid, and the separation performance can be obtained without being effected by the exchange of the sieving matrix even without using a sieving matrix cleaning liquid.

By exchanging the sieving matrix without using the sieving matrix cleaning liquid, the effects of cost reduction such as the reduction of the sieving matrix cleaning liquid, and the reduction of the sieving matrix capacity for replacing between the sieving matrix cleaning liquid and the sieving matrix, the reduction of the cleaning time of the sieving matrix cleaning liquid, the reduction of the filling time of the sieving matrix, and the like can be obtained, and further the usability of the user can be improved.

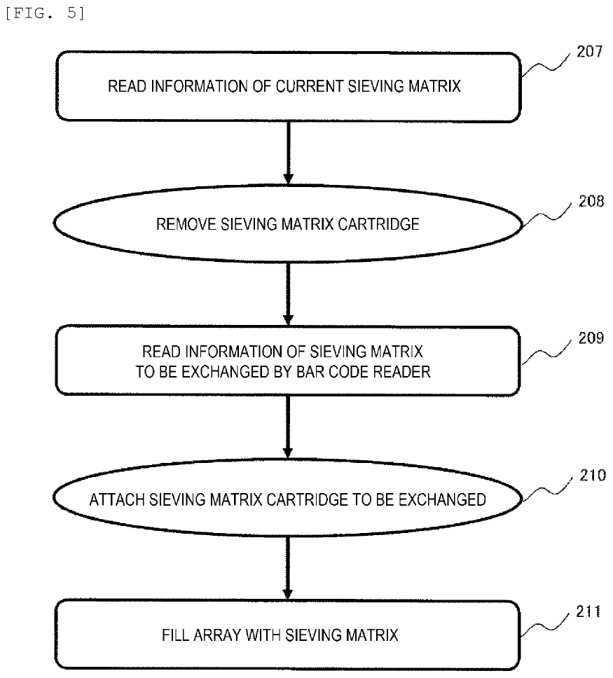

Based on the above, a workflow and a GUI in the exchange of different sieving matrices in the present embodiment will be described with reference to FIGS. 5 to 10. Further, the present apparatus includes a display unit on a front surface when the oven door 43 is closed. The display is performed by displaying a screen on the display unit.

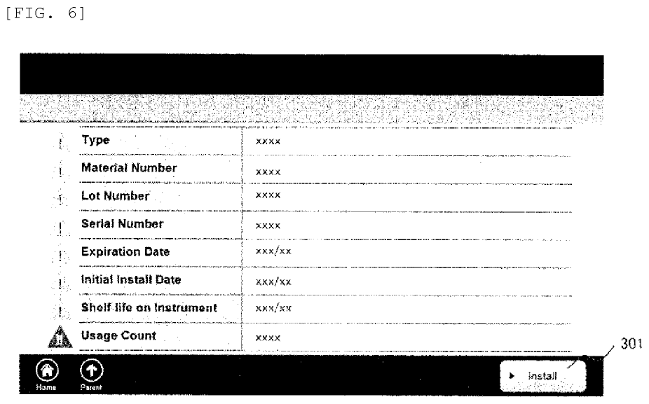

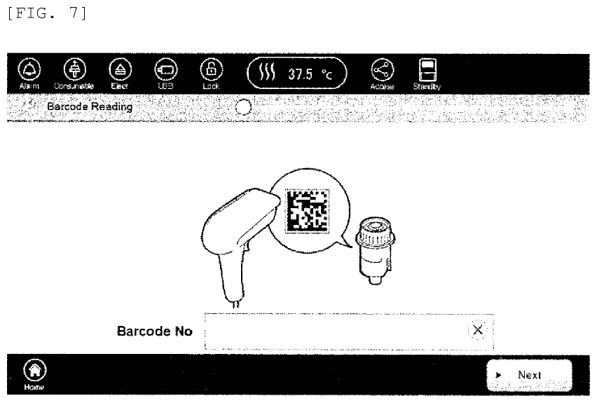

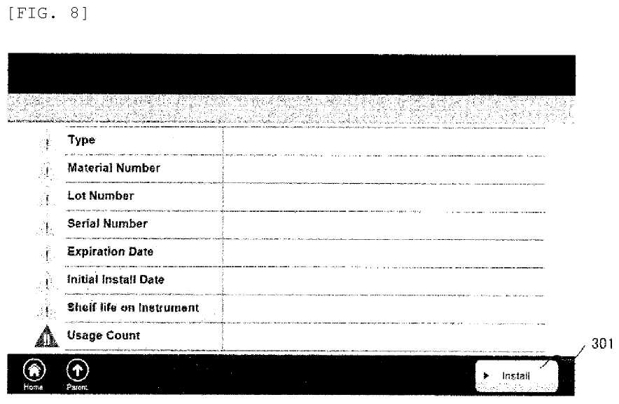

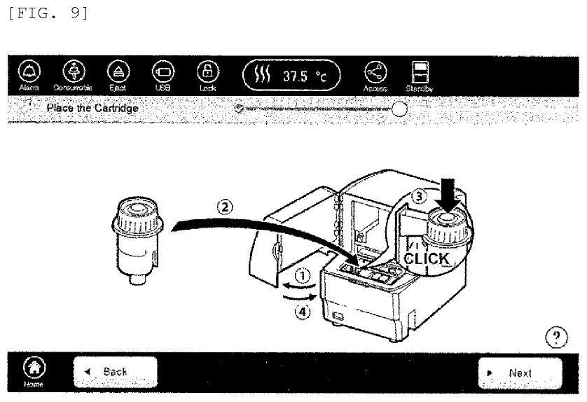

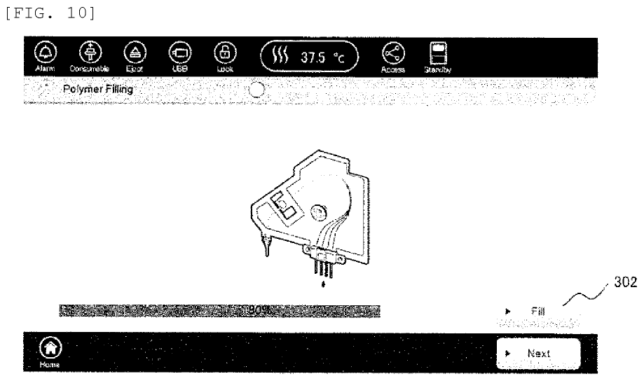

When the user selects a wizard of the sieving matrix exchange, in step 207 of FIG. 5, current sieving matrix information is displayed by the GUI of FIG. 6. The user confirms the displayed sieving matrix, presses an install button 301, and reads the sieving matrix information into the electrophoresis apparatus. Further, a GUI in which the sieving matrix to be exchanged is read is displayed in FIG. 7. In step 208, the user removes the sieving matrix cartridge before the exchange. Next, in step 209, bar code information of the sieving matrix to be exchanged is displayed by the bar code reader mounted on the apparatus. The information of the sieving matrix is displayed in FIG. 8, which can be confirmed by the user. After confirming the information of the sieving matrix, the user presses the install button 301 so as to read the information into the apparatus. In step 210, an instruction to attach a new sieving matrix cartridge is displayed in FIG. 9. In FIG. 9, a confirmation by a clicking sound at the time of attaching the sieving matrix cartridge is instructed. The confirmation assists the user in confirming that the sieving matrix cartridge is attached, and has an effect of preventing insufficient attachment of the sieving matrix cartridge. The user attaches a new sieving matrix cartridge, confirms the clicking sound, and then the workflow proceeds to the next step 211. FIG. 10 shows a screen on which the capillary can be filled with the sieving matrix. By pressing a filling start button 302 on a screen for starting a filling, the filling is started and a filling rate of the sieving matrix is displayed at any time. When the filling rate reaches 100%, the wizard of the sieving matrix exchange completes.

For the exchange of different sieving matrices in the present embodiment, the capillary electrophoresis apparatus not using the syringe pump is an example, and the method for exchanging the sieving matrix according to the invention described above without using the sieving matrix cleaning liquid can also be applied in an electrophoresis apparatus in which the capillary is filled with the sieving matrix using the syringe pump and the like.

### REFERENCE SIGN LIST

01 capillary cartridge
02 capillary
03 capillary head
04 electrode (cathode)
20 autosampler unit
21 sampler base
22 X-axis driver
23 Y-axis driver
24 Z-axis driver
25 sample tray
26 sample cartridge
27 liquid feeding mechanism
28 sieving matrix cartridge
29 anode buffer cartridge
30 anode electrophoresis buffer tank
31 anode cleaning tank
32 anode sample injection buffer tank
33 cathode buffer cartridge
34 waste liquid tank
35 cathode electrophoresis buffer tank
36 cathode cleaning tank
40 optics and oven unit
41 oven unit
42 optics unit
43 oven door
44 electrode (anode)
200 analysis work flowchart (set each consumable)
201 analysis work flowchart (maintain temperature of capillary)
202 analysis work flowchart (clean capillary)
203 analysis work flowchart (feed sieving matrix)
204 analysis work flowchart (inject sample)
205 analysis work flowchart (perform electrophoresis)
206 analysis work flowchart (analysis ends)
207 flowchart of sieving matrix exchange (read information on current sieving matrix)
208 flowchart of sieving matrix exchange (remove sieving matrix cartridge)
209 flowchart of sieving matrix exchange (read information on sieving matrix to be exchanged by bar code reader)
210 flowchart of sieving matrix exchange (attach sieving matrix cartridge to be exchanged)
211 flowchart of sieving matrix exchange (fill array with sieving matrix)
301 install button
302 filling start button

1.-8. (canceled)

9. An electrophoresis apparatus configured to perform electrophoresis of a sample in a capillary and optically detect the sample, the electrophoresis apparatus comprising:
the capillary filled with a sieving matrix and in which the electrophoresis of the sample is performed;
a sieving matrix cartridge in which the sieving matrix used for the electrophoresis is accommodated;
a liquid feeding mechanism configured to feed the sieving matrix accommodated in the sieving matrix cartridge to the capillary; and
an optics unit configured to optically detect the sample, wherein
an analysis workflow in which the liquid feeding mechanism feeds the sieving matrix to the capillary and the electrophoresis is performed in the capillary filled with the sieving matrix, and
a sieving matrix exchange workflow in which the liquid feeding mechanism feeds a sieving matrix to the capillary and the sieving matrix in the capillary is replaced with the above sieving matrix, are performed,
when a sieving matrix of the same type as the sieving matrix with which the capillary is filled is used in the analysis workflow, the analysis workflow is performed continuously, and
when a sieving matrix of a different type from the sieving matrix with which the capillary is filled is used in the analysis workflow, the analysis workflow is performed after the sieving matrix exchange workflow is performed.

10. The electrophoresis apparatus according to claim 9, wherein
in the sieving matrix exchange workflow, the sieving matrix that is equal to or larger than a capacity of the capillary is fed.

11. The electrophoresis apparatus according to claim 9, wherein
a viscosity of the sieving matrix is equal to or greater than 100 cp.

12. The electrophoresis apparatus according to claim 9 further comprising:
a display unit configured to instruct a confirmation of an attachment sound when the sieving matrix cartridge is attached.

13. The electrophoresis apparatus according to claim 12, wherein
the display unit displays an attachment position of the sieving matrix cartridge.

14. The electrophoresis apparatus according to claim 9, wherein
the capillary is inserted into the sieving matrix cartridge.

15. The electrophoresis apparatus according to claim 9, wherein
the liquid feeding mechanism is a syringe pump, and
the sieving matrix exchange workflow is performed without using a sieving matrix cleaning liquid.

16. The electrophoresis apparatus according to claim 9, wherein
different types of sieving matrices have different viscosities.

17. The electrophoresis apparatus according to claim 16, wherein
in the sieving matrix exchange workflow, a sieving matrix with a viscosity of 100 cp or more and a sieving matrix with a viscosity of 300 cp or more are exchanged.

18. An electrophoresis method for performing electrophoresis of a sample in a capillary and optically detecting the sample, the electrophoresis method comprising:
an analysis workflow including a step of feeding a sieving matrix to the capillary and a step of performing the electrophoresis in the capillary filled with the sieving matrix; and
a sieving matrix exchange workflow including a step of replacing the sieving matrix in the capillary with a sieving matrix, wherein
when a sieving matrix of the same type as the sieving matrix with which the capillary is filled is used in the analysis workflow, the analysis workflow is performed continuously, and
when a sieving matrix of a different type from the sieving matrix with which the capillary is filled is used in the analysis workflow, the analysis workflow is performed after the sieving matrix exchange workflow is performed.

19. The electrophoresis method according to claim 18, wherein
in the sieving matrix exchange workflow, the sieving matrix that is equal to or larger than a capacity of the capillary is fed.

20. The electrophoresis method according to claim 18, wherein
in the sieving matrix exchange workflow, the electrophoresis apparatus is configured to:
(a) display information of the sieving matrix provided in the electrophoresis apparatus,
(b) instruct an attachment of the sieving matrix cartridge, and
(c) read identification information of the sieving matrix cartridge filled with the sieving matrix, and
feed the sieving matrix.

21. The electrophoresis method according to claim 20, wherein
in step (b), a confirmation of a clicking sound at a time of attaching the sieving matrix cartridge is instructed.

22. The electrophoresis method according to claim 18, wherein
the sieving matrix is a liquid with a viscosity of 100 cp or more.

23. The electrophoresis method according to claim 22, wherein
in the sieving matrix exchange workflow, a sieving matrix with a viscosity of 100 cp or more and a sieving matrix with a viscosity of 300 cp or more are exchanged.
